(19) United States
(12) Patent Application Publication
(10) Pub. No.: US 2024/0113942 A1
(43) Pub. Date: Apr. 4, 2024

(54) NETWORK ASSET TRACKING USING GRAPH SIZE ESTIMATION

(71) Applicant: Meta Platforms, Inc., Menlo Park, CA (US)

(72) Inventor: Brandon Sloane, Lancaster, SC (US)

(73) Assignee: Meta Platforms, Inc., Menlo Park, CA (US)

(21) Appl. No.: 17/937,140

(22) Filed: Sep. 30, 2022

(51) Int. Cl. H04L 41/12

(52) U.S. Cl. CPC H04L 41/12

(57) ABSTRACT

Disclosed technology herein provides a computer-implemented method for asset tracking in a network having a plurality of connected devices, comprising generating a network graph based on network data captured at least in part via peer-to-peer polling, the network data including data relating to tracked assets in a network, where the peer-to-peer polling is used to validate a presence of at least a portion of the tracked assets in the network, generating an estimated size of the network graph using a graph estimation algorithm, determining an estimate of the tracked assets based on the estimated size of the network graph, and determining one or more remediation actions in response to the estimate of the tracked assets, where at least a portion of the network graph can be stored in a decentralized manner. The graph estimation algorithm can include a random walk algorithm, a random sampling algorithm, and/or an induced edges algorithm.

### TECHNICAL FIELD

Embodiments generally relate to computing systems. More particularly, embodiments relate to estimation and tracking of assets within a networked computing infrastructure.

### BACKGROUND

Managing assets in a networked environment presents unique challenges. For example, software applications represent key technology assets for enterprises, and it is important to have a good understanding of what the software installations look like for an enterprise. Yet it can be very difficult to track installations and active users for a given software asset, such as a software application. Current asset tracking solutions include, for example, those that rely upon active polling agents to maintain a software asset inventory, while other solutions monitor software assets through centralized asset management systems that attempt to track installations and deinstallations as they occur and then report out on the current figures. Such asset tracking solutions have drawbacks, however. For example, use of polling agents introduces processing overhead that negatively impacts performance of both centralized systems and end user equipment, and can provide unreliable (e.g., non-normalized data). Similarly, centralized asset management systems are difficult to maintain and often fail to provide reliable information. Additionally, these systems have difficulty in tracking assets of an intermittent or transient nature.

### SUMMARY OF PARTICULAR EMBODIMENTS

In accordance with one or more embodiments, a computer-implemented method for asset tracking in a network having a plurality of connected devices includes generating a network graph based on network data captured at least in part via peer-to-peer polling, the network data including data relating to tracked assets in a network, wherein the peer-to-peer polling is used to validate a presence of at least a portion of the tracked assets in the network, generating an estimated size of the network graph using a graph estimation algorithm, determining an estimate of the tracked assets based on the estimated size of the network graph, and determining one or more remediation actions in response to the estimate of the tracked assets.

In accordance with one or more embodiments, a computing system includes a processor, and a memory coupled to the processor, the memory comprising instructions which, when executed by the processor, cause the computing system to perform operations including generating a network graph based on network data captured at least in part via peer-to-peer polling, the network data including data relating to tracked assets in a network, wherein the peer-to-peer polling is used to validate a presence of at least a portion of the tracked assets in the network, generating an estimated size of the network graph using a graph estimation algorithm, determining an estimate of the tracked assets based on the estimated size of the network graph, and determining one or more remediation actions in response to the estimate of the tracked assets.

In accordance with one or more embodiments, at least one computer readable storage medium includes a set of instructions which, when executed by a computing device, cause the computing device to perform operations including generating a network graph based on network data captured at least in part via peer-to-peer polling, the network data including data relating to tracked assets in a network, wherein the peer-to-peer polling is used to validate a presence of at least a portion of the tracked assets in the network, generating an estimated size of the network graph using a graph estimation algorithm, determining an estimate of the tracked assets based on the estimated size of the network graph, and determining one or more remediation actions in response to the estimate of the tracked assets.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram illustrating an example of a networked infrastructure environment for network asset tracking according to one or more embodiments;

FIG. 2 is a block diagram illustrating an example of a network asset tracking system according to one or more embodiments;

FIG. 3A is a block diagram illustrating aspects of an example network graph generator according to one or more embodiments;

FIGS. 3B-3F provide diagrams illustrating examples of network graph generation according to one or more embodiments;

FIG. 4A is a block diagram illustrating aspects of an example graph estimator according to one or more embodiments;

FIG. 4B is a block diagram illustrating aspects of an example asset estimator according to one or more embodiments;

FIG. 5 is a block diagram illustrating aspects of an example dashboard and reporting interface according to one or more embodiments;

FIG. 6 is a block diagram illustrating aspects of an example integration module according to one or more embodiments;

FIG. 7 is a flow diagram illustrating an example of a method of tracking network assets according to one or more embodiments; and

FIG. 8 is a block diagram illustrating a computing system for use in a network asset tracking system according to one or more embodiments.

### DESCRIPTION OF EMBODIMENTS

The technology as described herein provides an improved computing system for tracking network assets in a networked environment. Using peer-to-peer polling to help generate a network graph for network data including data relating to tracked assets in a network, and graph estimation algorithms for estimating a size of the network graph, the technology helps improve the efficiency and reliability of asset tracking systems, as well as assist administrators in monitoring network performance and security.

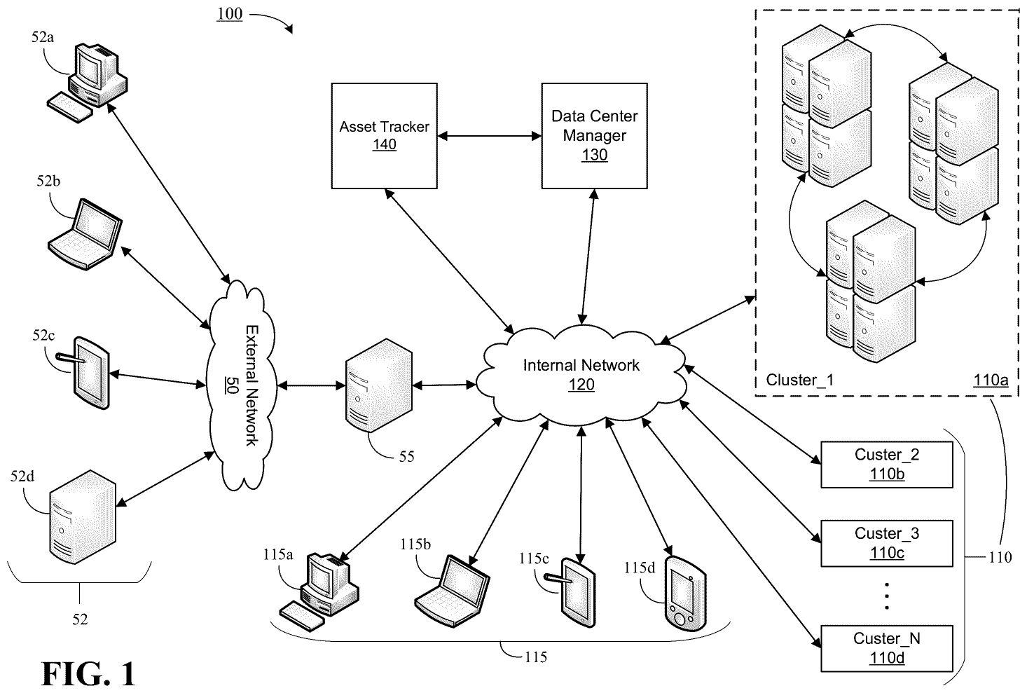

FIG. 1 provides a block diagram illustrating an example of a networked infrastructure environment 100 for network asset tracking according to one or more embodiments, with reference to components and features described herein including but not limited to the figures and associated description. As shown in FIG. 1, the networked infrastructure environment 100 includes an external network 50, a plurality of external user or client devices 52 (such as example external client devices 52a-52d), a network server 55, a plurality of server clusters 110 (such as example clusters 110a-110d), a plurality of internal user or client devices 115 (such as example internal client devices 115a-115d), an internal network 120, a data center manager 130, and a network asset tracking system 140. The external network 50 is a public (or public-facing) network, such as the Internet. The client devices 52a-52d are devices that communicate over a computer network (such as the Internet) and can include devices such as a desktop computer, laptop computer, tablet, mobile phone (e.g., smart phone), etc. The client devices 52a-52d can operate in a networked environment and run application software, such as a web browser, to facilitate networked communications and interaction with other remote computing systems, including one or more servers, using logical connections via the external network 50.

The network server 55 is a computing device that operates to provide communication and facilitate interactive services between users (such as via client devices 52a-52d) and services hosted within a networked infrastructure via other servers, such as servers in clusters. For example, the network server 55 can operate as an edge server or a web server. In embodiments, the network server 55 is representative of a set of servers that can range in the tens, hundreds or thousands of servers. The networked services can include services and applications provided to thousands, hundreds of thousands or even millions of users, including, e.g., social media, social networking, media and content, communications, banking and financial services, virtual/augmented reality, etc.

The networked services can be hosted via servers, which in embodiments can be grouped in one or more server clusters 110 such as, e.g., one or more of Cluster_1 (110a), Cluster_2 (110b), Cluster_3 (110c) through Cluster N (110d). The servers/clusters are sometimes referred to herein as fleet servers or fleet computing devices. Each server cluster 110 corresponds to a group of servers that can range in the tens, hundreds or thousands of servers. In embodiments, a fleet can include millions of servers and other devices spread across multiple regions and fault domains. In embodiments, each of these servers can share a database or can have their own database (not shown in FIG. 1) that warehouse (e.g. store) information. Server clusters and databases can each be a distributed computing environment encompassing multiple computing devices, and can be located at the same or at geographically disparate physical locations. Fleet servers, such as the servers in clusters 110, can be networked via the internal network 120 and managed via a data center manager 130.

The client devices 115a-115d are devices that communicate over a computer network (such as the internal network 120) and can include devices such as a desktop computer, laptop computer, tablet, mobile phone (e.g., smart phone), etc. The client devices 115a-115d can operate in a networked environment and run application software, such as a web browser, to facilitate networked communications and interaction with other devices in the networked environment using logical connections via the internal network 120, and can further interact with remote computing systems, including one or more client devices or servers, using logical connections via the external network 50.

A key aspect of a networked environment is the nature and number of assets contained or used in the network. In embodiments, network assets of interest include one or more of the following: software programs such as, e.g., software applications, operating systems, other software programs, etc.; user devices such as, e.g., laptops, desktops, mobile devices (including smartphones, tablets, etc.), servers, cloud networking devices, virtual machines, etc. For example, virtual network machines or devices can have IP addresses that are ephemeral or transitory, and in many cases cloud assets include the use of virtual machines. Thus tracking virtual machines or cloud assets can present unique challenges. In embodiments, assets of interest can include enterprise or organization-supplied assets and/or user-supplied assets (including, e.g., bring your own devices).

Asset tracking in accordance with embodiments as described herein provides significant advantages in network security and performance. For example, the ability to reliably estimate and track assets can impact networks in several ways:
(1) the technology can estimate software installations or hardware devices in the network having a certain version (e.g., compared to assets not updated to a certain version), which enables estimating assets, e.g., having known security vulnerabilities or performance weaknesses;
(2) the technology can estimate the presence of third party applications or devices in the network (e.g., unauthorized assets or assets from vendors known to provide software or hardware having security issues), which enables estimating assets presenting additional or unknown security vulnerabilities as well as potential performance drain on the network;
(3) the technology can estimate the number of devices in any particular area or zone, which enables determining, e.g., whether there are too many devices in a particular zone that drives network performance down, or whether there is excess capacity in a zone that can be better utilized;
4) the technology can estimate the presence of software or hardware assets in the wrong location or zone, which enables estimating potential security risks or performance problems presented by these out-of-place assets;
(5) the technology can estimate the presence of software or hardware assets having an intermittent or transitory presence (e.g., software applications or hardware devices operated only intermittently), which enables estimating the presence of such assets that otherwise are very difficult to track because of the intermittent transitory nature.

To help address performance and security issues such as those identified above, the network asset tracking system 140 is provided to track network assets. As described further herein, the network asset tracking system 140 operates to construct a network graph using peer-to-per polling, estimate the size of the network graph, determine an estimate of the network assets present in the network, and determine one or more remediation actions in response to the estimate of the tracked assets.

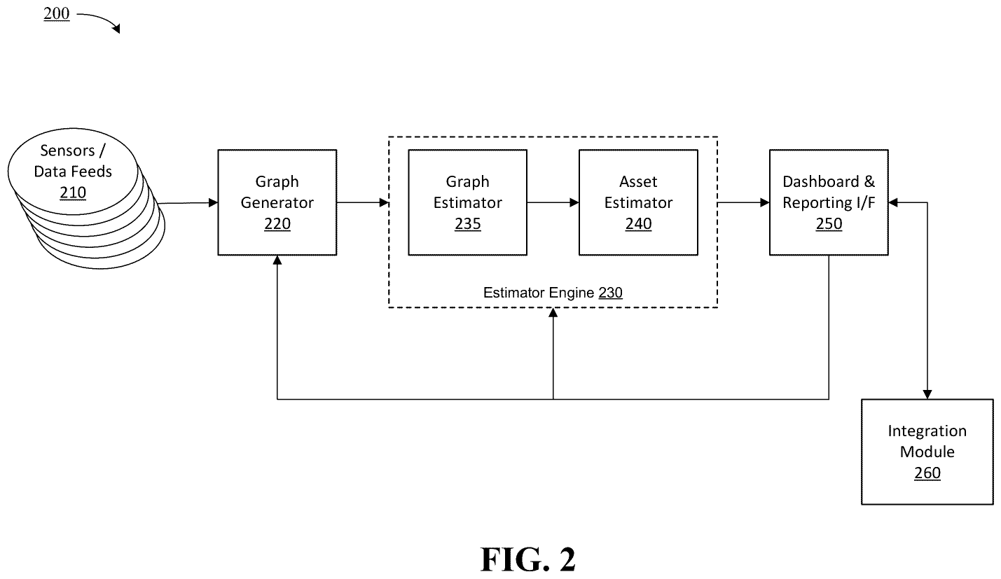

FIG. 2 provides a block diagram illustrating an example of a network asset tracking system 200 according to one or more embodiments, with reference to components and features described herein including but not limited to the figures and associated description. In embodiments, the network asset tracking system 200 corresponds to the network asset tracking system 140 (FIG. 1, already discussed). As shown in FIG. 2, in embodiments the system 200 includes sensors and data feeds 210, a network graph generator 220, an estimator engine 230 (including a graph estimator 235 and an asset estimator 240), a dashboard and reporting interface 250, and an integration module 260.

The sensors and data feeds 210 provide network data such as, e.g., network traffic data and/or information regarding assets in the network. The sensors and data feeds 210 include, in some embodiments, individual software sensors (node sensors) placed on each node in the network (or at least on a plurality of nodes in the network). Nodes in the network can include any one or more of the devices shown in the networked infrastructure environment 100, and can include other networked devices or components not shown in FIG. 1 (e.g., routers, switches, etc.). Nodes can include any devices in communication in the network, e.g., any devices having an internet protocol (IP) address or a media access control (MAC) address. Nodes can be organized in zones or layers in the network. Nodes in a network graph can include any network presence (e.g., device or endpoint) having a particular network asset of interest to be tracked or estimated, with communication pathways between such nodes represented by edges in the network graph. For example, endpoints or devices having a particular installation of a software application or program can be represented by a node in the network graph.

In some embodiments, the sensors and data feeds 210 include sensors on devices at the network layer such as, e.g., routers and switches. In some embodiments, the sensors and data feeds 210 include software sensors on nodes or on network layer devices which act as a collection agent for network layer traffic. In some embodiments, the sensors and data feeds 210 include one or more feeds from existing network sensing and data collection system(s). In embodiments, the sensors and data feeds 210 include a plurality of or all of the foregoing components. Key data elements collected and/or received from the sensors and data feeds 210 can include uniquely identifiable node information such as, e.g., network hardware addressing, routing information, and various metadata from network traffic transmissions. For example, data collected from nodes can identify particular network asset of interest to be tracked or estimated.

In some embodiments, network data is collected for every node in the network, while in other embodiments network data is collected for a subset of network nodes. Collection of network data varies, in embodiments, based on the type or class of node. For example, mobile devices are, in some embodiments, subject to collection of higher detail of network data. For example, in embodiments more detailed traffic data is collected for certain classes of nodes such as, e.g., nodes (devices) for administration users, nodes (devices) for known high-risk users, etc., nodes (devices) for all employees, etc. In embodiments, network data collected depends on network topology, node location, etc. For example, nodes in foreign jurisdictions are, in some embodiments, subject to collection of higher detail of network data.

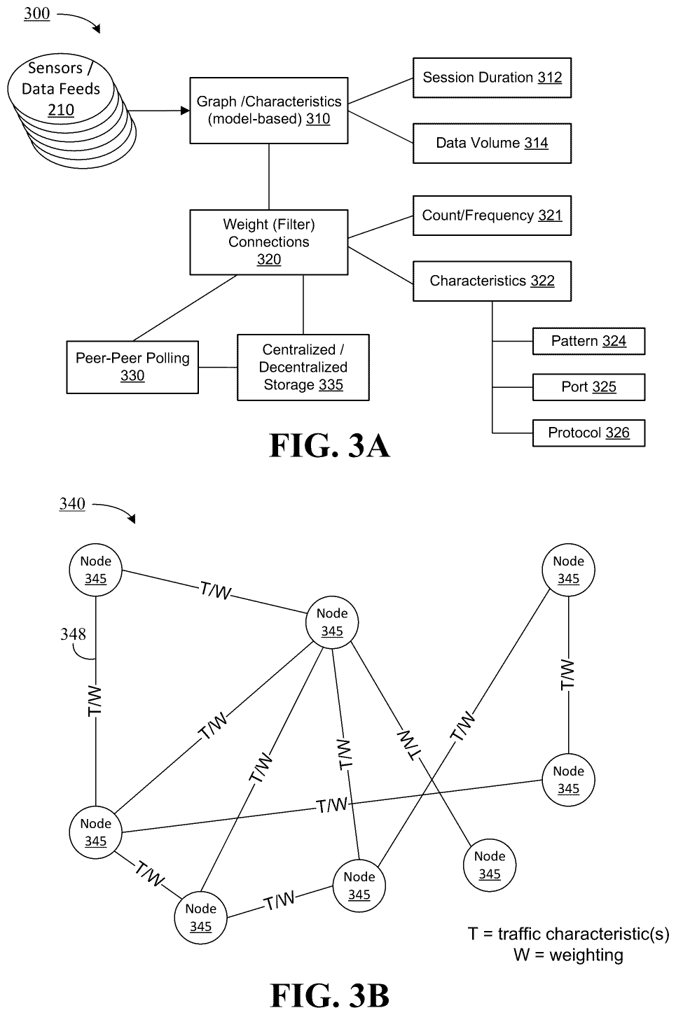

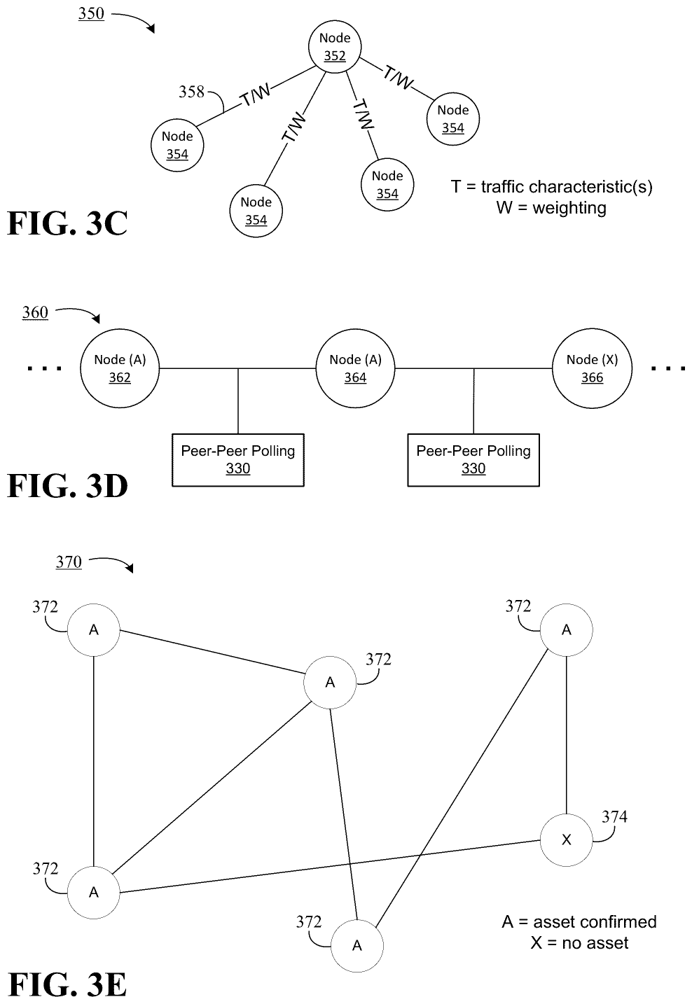

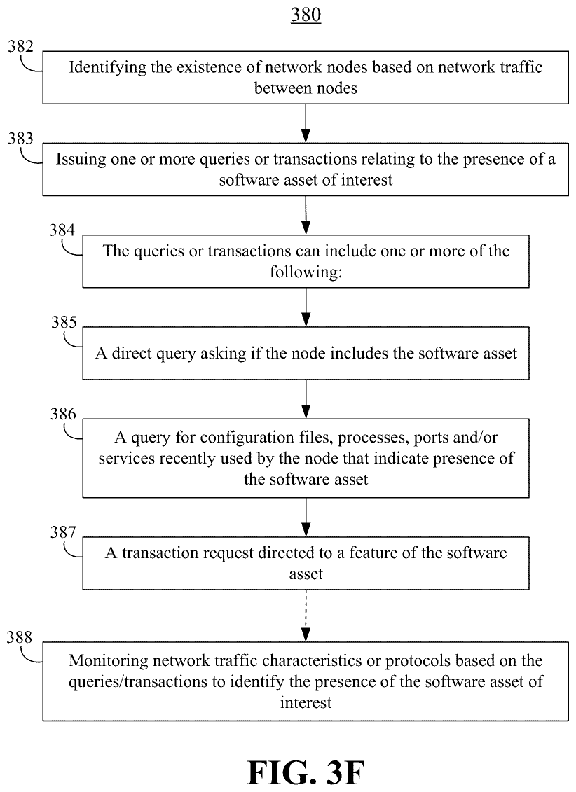

The network graph generator 220 utilizes and builds upon existing graphing algorithms (including social graphing algorithms) to generate, for each node, a unique graph of other nodes relating to that specific node being mapped. In some embodiments, graphing algorithms leverage measures of network centrality including but not limited to one or more of the degrees for each particular node, measures of closeness to other nodes on the graph (e.g., number of network hops required between those nodes), measures of betweenness to other nodes on the graph (e.g., latency between nodes), etc. or more advanced mathematical representations such as, e.g., EigenVector or measures of iterative circles. These graphs are generated based on the network data provided by the sensors and data feeds 210, and provide information on relationships between nodes. The network graph generator obtains sufficient network data to enable the estimator engine 230 to generate accurate and reliable estimates for the overall network (or network segment). Further details regarding the network graph generator 220 are described herein with reference to FIGS. 3A-3F.

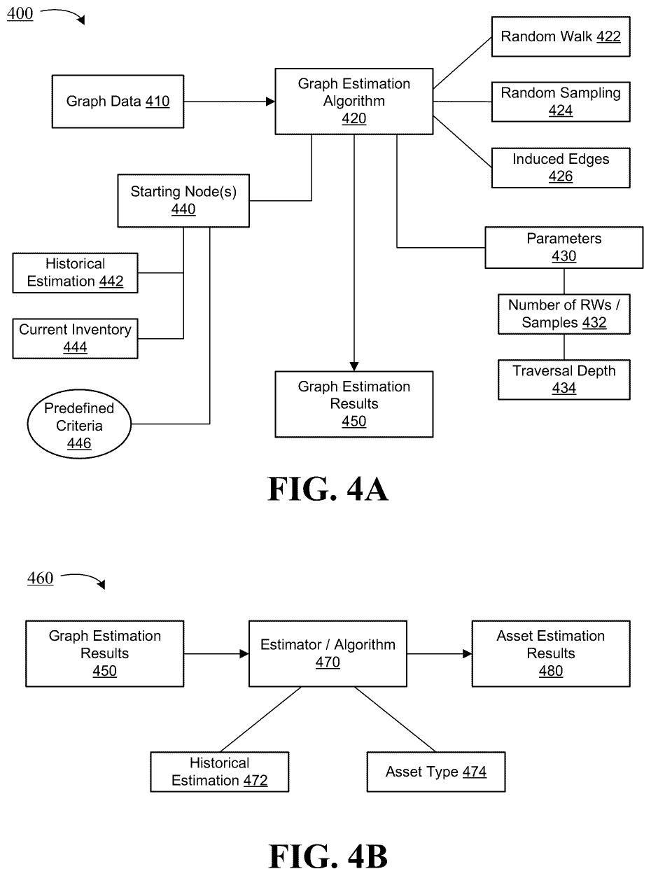

The estimator engine 230 includes two components, the graph estimator 235 and the asset estimator 240. The graph estimator 235 operates to estimate (e.g., predict) the size of a network graph (or portions of a network graph) based on utilizing one or more graph estimation algorithms. Estimated (e.g., predicted) network graph size is based on the graphs generated by the network graph generator 220. The asset estimator 240 operates to evaluate the estimated network graph size and provide an estimate (e.g., prediction) of the network assets of interest. In some embodiments, the graph estimator 235 and the asset estimator 240 are integrated into a single module. Further details regarding the graph estimator 235 and the asset estimator 240 are described herein with reference to FIGS. 4A-4B.

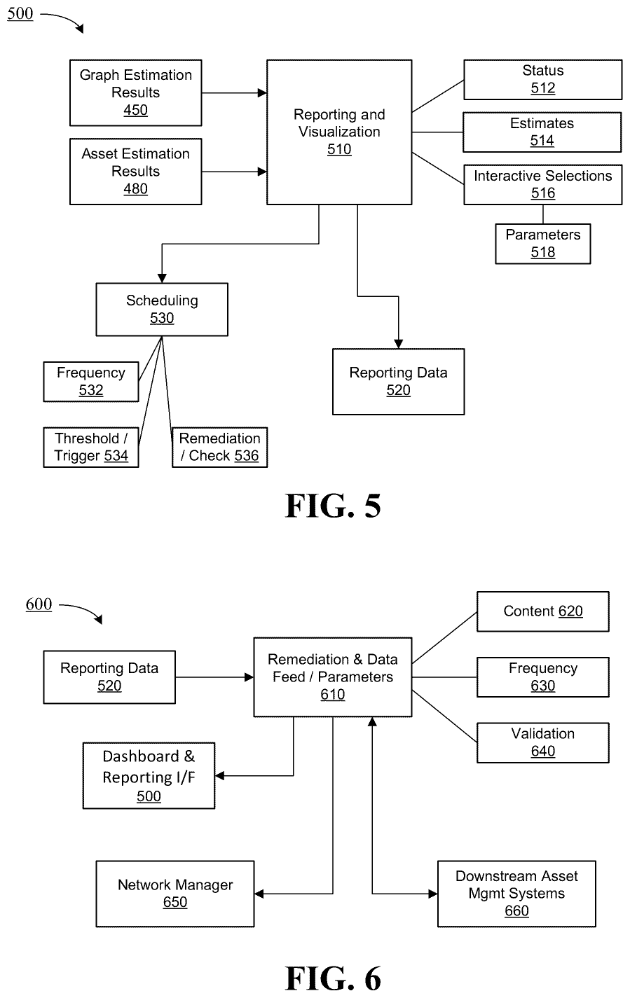

The dashboard and reporting interface 250 provides reporting status and information to users (e.g., administrators) regarding the estimated network assets from the estimator engine 230. Additionally, the dashboard and reporting interface 250 provides visualization of the network information as well as providing for scheduling of data collection and asset estimation. Further details regarding the dashboard and reporting interface 250 are described herein with reference to FIG. 5.

The integration module 260 provides for integrating network asset information from the dashboard and reporting interface 250 with downstream asset management systems, and in embodiments includes providing modified parameters (e.g., for scheduling) and/or remediation. Further details regarding the integration module 260 are described herein with reference to FIG. 6.

Some or all components in the system 200 can be implemented using one or more of a central processing unit (CPU), a graphics processing unit (GPU), an artificial intelligence (AI) accelerator, a field programmable gate array (FPGA) accelerator, an application specific integrated circuit (ASIC), and/or via a processor with software, or in a combination of a processor with software and an FPGA or ASIC. More particularly, components of the system 200 can be implemented in one or more modules as a set of program or logic instructions stored in a machine- or computer-readable storage medium such as random access memory (RAM), read only memory (ROM), programmable ROM (PROM), firmware, flash memory, etc., in hardware, or any combination thereof. For example, hardware implementations can include configurable logic, fixed-functionality logic, or any combination thereof. Examples of configurable logic include suitably configured programmable logic arrays (PLAs), FPGAs, complex programmable logic devices (CPLDs), and general purpose microprocessors. Examples of fixed-functionality logic include suitably configured ASICs, combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations by the system 200 can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 3A provides a block diagram illustrating aspects of an example network graph generator 300 according to one or more embodiments, with reference to components and features described herein including but not limited to the figures and associated description. In embodiments, the network graph generator 300 corresponds to the network graph generator 220 (FIG. 2, already discussed). The network graph generator 300 receives network data from the sensors and data feeds 210 (which can include, e.g., a first set of network data captured in a first time frame) and operates to generate, using graph algorithms, one or more graphs for each node (block 310). As such, the network graph generator 300 operates to normalize and organize the network data, and provide for historic data e.g., in the form of stored graphs. The graphs provide information about relationships between nodes that can have various magnitudes/strengths and characteristics. In some embodiments, as a network graph is being constructed, passive agents (not active agents) can be utilized to confirm a node presence (e.g., acknowledging a query) or to assist in identifying a next node hop (e.g., identifying a neighboring node).

Graphs can be generated flexibly based on a variety of desired insights (e.g., based on models of network behavior) and can be evidence-based or outcome-based. Characteristics regarding node relationships can include one or more aspects such as, e.g., transaction or session duration (block 312) and/or volume of data transferred (block 314). Filtering can be applied as a weighting to node connections (block 320). Filtering can include or be based on one or more aspects such as, e.g., a count or frequency of transmissions (block 321), and/or characteristics of network data (block 322). In embodiments, filtering is based on characteristics such as a particular pattern of network traffic (block 324), communication over a particular port (block 325), and/or communication using a particular protocol (block 326). In embodiments, different filtering or weighting is applied based on the kind of graph or graph characteristics (e.g., providing various perspectives). In some embodiments, the network data is a first set of network data captured in a first time frame. In embodiments, multiple graphs are generated for one or more nodes depending on network data characteristics, thresholds for observed network traffic, etc.

Peer nodes can be used to capture network traffic between neighboring nodes (e.g., nodes having communication pathways between them and/or connected nodes), which can be used to identify connectivity patterns represented by the traffic and construct edges between nodes. Peer-to-peer polling (block 330) is conducted (e.g., performed) in embodiments to validate (e.g., confirm) the presence of at least a portion of tracked assets in the network. For example, peer nodes make requests to each other for network data reflective of the asset being tracked. As one example, peer nodes can request of each neighboring peer node information regarding the installation of a particular software application, a version number of the application, etc. As another example, peer nodes can monitor network traffic from neighboring peer nodes to determine whether a particular traffic characteristic is present, indicating the presence of a particular software or hardware asset. Thus, for example, peer nodes can identify or learn which of their neighboring nodes meets criteria for determining the presence or absence of a particular asset (e.g., a type of software asset such as a particular application, or a hardware device having a particular hardware feature, etc.). By using peer nodes as described herein, the peer nodes are effectively assisting in the building of a network graph. Further details regarding the use of peer-to-peer polling are provided with reference to FIGS. 3D-3F herein.

In some embodiments graphing varies across different nodes based on different classes of nodes and relative importance of those nodes. For example, in a trusted resource zone for critical systems, the system 200 can gather extremely detailed network traffic information and construct very elaborate graphs. In some embodiments, these graphs might contain and or leverage detailed information about both the nature and context of transactions between nodes including but not limited to different classes of application layer traffic, port information, encryption algorithm information, user authentication protocols, authentication transaction information, and even application session information such as specific commands issued or data transferred. By contrast, in more general network segments, the system can be designed to only capture generic metadata around transmission information.

In embodiments, generated graph data is stored in a centralized or decentralized fashion, depending on defined traffic data and characteristics to be collected and fed into the graphing algorithms (block 335). For example, in embodiments generated graph data is stored in a centralized database for use by the network asset tracking system 200 and/or by another command/control system in the networked environment (such as, e.g., the data center manager 130). Thus, in embodiments with fully or primarily centralized graph generation and storage, network data traffic collected at nodes is passed to a central resource (e.g., the network asset tracking system 200), which handles graph generation, behavioral analysis and remediation. In embodiments, generated graph data is stored in a decentralized manner such as, e.g., in the individual nodes, and graph data is generated on these individual nodes to be queried by the network asset tracking system 200 and/or by another command/control system. Thus, in embodiments with fully or primarily decentralized graph generation and storage, network data traffic collected at nodes is stored via local resources, which handles graph generation and (local) network behavioral analysis. Network graph data can be reported to a central resource (e.g., the network asset tracking system 200) for further analysis, aggregation and estimation.

In embodiments, peer-to-peer validation is conducted (e.g., performed) as an integrity check on the generated graphs for decentralized graph data storage. For example, peer nodes make requests to each other for their respective graphs (e.g., graph data) and then validate whether the peer node graphs reflect what the requesting node perceives to be an accurate representation of the traffic patterns of that requesting node. In cases where there is a potential mapping integrity issue, an alert can be generated and sent to the system 200 for remediation. In embodiments, remediation actions include the issuance of commands to a particular node or set of nodes including but not limited to, one or more of regenerating graph representations, reassembling underlying graph data, ignoring certain aspects of a graph or graph data, or designating certain aspects of a graph or graph data as authoritative and overwriting other aspects of a graph or graph data on other nodes. In embodiments, validation reports (including successful validation) can be provided to the system 200.

In embodiments, a hybrid arrangement includes both centralized and decentralized storage, where data is first gathered on decentralized individual nodes, where initial graphs are constructed, and then the data and graphs are aggregated centrally for use by the network asset tracking system 200 and/or by another command/control system. In some hybrid embodiments, aspects of network analysis are conducted or processed locally (e.g., to examine peer-to-peer communications) and reported to a central resource (e.g., the network asset tracking system 200) for further network analysis (including, e.g., graph aggregations) and remediation.

In embodiments with high degrees of individual node activity and traffic, a decentralized data storage and graph generation implementation provides preprocessing capabilities as part of graph generation. For example, node contextual graph generation can take into consideration factors such as the type or function of a particular node. Thus, different nodes make different decisions regarding the types of network data monitored/prioritized for collection or the types of graphs to be generated therefrom. As one example, nodes operating as a critical resource can prioritize certain types of network traffic (e.g., domain controller traffic) and/or traffic having critical confidentiality or security features. Other nodes can deemphasize certain types of traffic that would be rarely seen by that node. In embodiments with more interconnectedness and relative importance on contextual representation of network data as they pertain to other nodes, a centralized data storage and graph generation implementation provides greater opportunities for constructing relatedness measurements between transactional graph representations.

Some or all aspects of the network graph generator 300 as described herein can be implemented via a central processing unit (CPU), a graphics processing unit (GPU), an artificial intelligence (AI) accelerator, a field programmable gate array (FPGA) accelerator, an application specific integrated circuit (ASIC), and/or via a processor with software, or in a combination of a processor with software and an FPGA or ASIC. More particularly, aspects of the network graph generator 300 can be implemented in one or more modules as a set of program or logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations of the network graph generator 300 can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 3B provides a diagram illustrating an example of a graph 340 generated by the network graph generator 300 according to one or more embodiments, with reference to components and features described herein including but not limited to the figures and associated description. The graph 340 is based on aggregated network data from a plurality of nodes 345 having edges 348 representing connections between nodes 345 based on collected traffic data. The edges 348 include traffic characteristics T (e.g., characteristics per block 310) and weighting W (e.g., weighted or filtered connections per block 320).

Edges provide a multi-dimensional characterization relationship (including, e.g., network traffic) between any two nodes. For example, characterizations of network traffic between nodes can include one or more of the following: network port, application, encryption (or lack of encryption), session duration, quantity of data transferred, historical relationship (e.g., routine or common interactions, rarity, etc.), time, location, etc. In embodiments, characteristics tracked over time for traffic between nodes can be modified based, e.g., on machine learning to determine which characteristics provide impactful information regarding tracked network assets.

The graph 340 is constructed, e.g., based on network graphs or graph data generated for individual nodes 345 (such as, e.g., illustrated in FIG. 3C). In embodiments, the network graph generator 300 can map network interactions based on applications or sessions. In embodiments, the network graph generator 300 can map network interactions based on layer in the open systems intercommunication (OSI) stack such as, e.g., session layer, transport layer, etc. In embodiments, application layer interactions include but are not limited to one or more of authentication, issuance of application commands, transfer/retrieval or modification of data. In embodiments, network layer interactions include but are not limited to one or more of ports utilized, services running, network encryption protocols, subnet information, route information, hops, latency, or packet information.

In some embodiments, mapping provides multiple edges between nodes. For example, in some embodiments each transaction between nodes results in a separate edge. As an example for such embodiments, if a user with a laptop connects to an e-mail server, each download or upload of emails between the laptop and e-mail server results in a separate edge. In other embodiments, an edge represents multiple transactions between nodes. As an example for such other embodiments, if a user with a laptop connects to an e-mail server, multiple downloads and uploads of emails (e.g., within the time frame for collecting the current network traffic) between the laptop and e-mail server results in a single edge representing interaction details for multiple transactions.

FIG. 3C provides a diagram illustrating an example of a graph 350 generated by the network graph generator 300 according to one or more embodiments, with reference to components and features described herein including but not limited to the figures and associated description. The graph 350 is based on graph data from a node 352 relating to its neighboring nodes 354, with edges 358 representing connections between node 352 and the neighbor nodes 354 based on collected traffic data. The edges 358 include traffic characteristics (e.g., characteristics per block 310) and weighting (e.g., weighted connections per block 320).

FIG. 3D provides a diagram illustrating an example of a polling process 360 used for conducting peer-to-peer polling (e.g., peer-to-peer polling in block 330 of FIG. 3A, already discussed) according to one or more embodiments, with reference to components and features described herein including but not limited to the figures and associated description. Peer-to-peer polling is conducted between connected nodes in a network such as, e.g., nodes 362, 364 and 366 illustrated in FIG. 3D. As illustrated in the example of FIG. 3D, a first node 362 includes a tracked asset (indicated by the letter A). In response to a query from a second node 364, the first node 362 provides information to confirm the presence of the asset (A) to the second node 364. In embodiments, the first node 362 also confirms the presence of the asset (A) to another connected peer node (not shown in FIG. 3E). The first node 362 issues a query to the second node 364, which in the illustrated example also includes the tracked asset (A). In response, the second node 364 provides information to confirm the presence of the asset (A) to the first node 362.

The second node 364 also issues a query to a third node 366, which in the illustrated example does not include the tracked asset (absence of the tracked asset is indicated by the letter X). In response, the third node 366 provides information to confirm the absence of the tracked asset to the second node 364. In embodiments, absence of the asset in the third node 366 can additionally or alternatively be determined via, e.g., an absence of a response by the third node 366 to the query from the second node 364, or an absence of a type or character of network data in traffic between the second node 364 and the third node 366. As an example, if particular network data characteristic(s) (e.g., as described with reference to blocks 322 and 324-326 in FIG. 3A) are missing or filtered out, this can indicate the absence of a tracked asset in the third node 366.

FIG. 3E provides a diagram illustrating an example of a graph 370 generated by the network graph generator 300 via the peer-to-peer polling process 360 according to one or more embodiments, with reference to components and features described herein including but not limited to the figures and associated description. As shown in FIG. 3E, the graph 370 includes a series of nodes 372 in which the presence of tracked assets have been confirmed (indicated by the letter A in the node). Edges represent communication pathways (e.g., connections) between nodes. As shown in FIG. 3E, for one node 374 (indicated by the letter X in the node) in the example graph 370, the tracked asset is not present (or at least the presence of the tracked asset could not be confirmed). In embodiments where network data characteristics are filtered (e.g., based on the type of tracked asset), the node 374 may be missing entirely from the graph; for example, as a result of filtering, the edges between node 374 and other nodes 372 would not be discovered or verified.

FIG. 3F provides a diagram illustrating an example of a process 380 for generating a network graph according to one or more embodiments, with reference to components and features described herein including but not limited to the figures and associated description. While the example process 380 relates to tracking a software asset, in some embodiments tracking a hardware asset can include similar elements. Illustrated processing block 382 provides for identifying nodes (e.g., the existence of network nodes) based on network traffic between nodes. Illustrated processing block 383 provides for issuing one or more queries or transactions relating to the presence of a software asset of interest, where at block 384 the queries/transactions can include one or more of the following: a direct query asking if the node includes the software asset (block 385); a query for configuration files, processes, ports and/or services recently used by the node that indicate presence of the software asset (block 386); and/or a transaction request directed to a feature of the software asset (block 387). In some embodiments, block 388 provides for monitoring network traffic characteristics or protocols based on the queries/transactions to identify (e.g., via characteristics unique to the software asset) the presence of the software asset of interest. In some embodiments using such monitoring, presence of the asset in a node would reveal the node/edges, while absence of the asset in a node would leave the node to remain hidden. In some embodiments, aspects of the foregoing queries/transactions/monitoring are implemented via peer-to-peer polling.

The process 360 and/or the process 380 can generally be implemented in the network graph generator 300 (FIG. 3A, already discussed). More particularly, the process 360 and/or the process 380 can be implemented as one or more modules as a set of logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations shown in the process 360 and/or the process 380, and/or functions associated therewith, can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 4A provides a block diagram illustrating aspects of an example graph estimator 400 according to one or more embodiments, with reference to components and features described herein including but not limited to the figures and associated description. In embodiments, the graph estimator 400 corresponds to the graph estimator 235 (FIG. 2, already discussed). The graph estimator 400 receives input graph data 410 from the network graph generator 300 (e.g., the network graph generator 220). In embodiments the graph data 410 includes data regarding tracked assets in the network. The graph estimator 400 applies one or more graph estimation algorithm(s) 420 and generates graph estimation results 450.

The graph estimation algorithm(s) 420, in embodiments, include or utilize one or more of a random walk (block 422), a random sampling (block 424), and/or induced edges (block 426). In embodiments, a random walk algorithm (block 422) is applied that performs randomized sampling and traversal of the defined nodes and edges of the network graph (as represented by the input graph data 410). For example, a starting node is determined, and based on the starting node it neighboring node(s) are identified and examined to determine the presence of the asset of interest. The process then proceeds from for each neighboring node to each of their subsequent neighboring node(s), and so on until a threshold number of levels of the graph have been traversed.

In embodiments, a random sampling algorithm (block 424) is applied that begins with a number of independent, randomly selected starting nodes, where each starting node checks its neighboring nodes, with the collection of sampled node data providing a graph estimate. In embodiments, an induced edges (e.g., graph induction) algorithm (block 426) begins at a starting node selected, e.g., based on nodes having a high degree of edges. In embodiments, the induced edges technique traverses the graph data based on edges or edge data with other nodes. Thus, for example, in embodiments the algorithm traverses the graph data based on following the paths with a higher number of edges. In some embodiments, the algorithm traverses the graph data based on paths/edges having a particular characteristic, e.g., one that would relate to or identify an asset. For example, where software assets communicate with other software assets (such as, e.g., an e-mail program), the edges can identify the e-mail communication, and these edges can be used to traverse the graph data based on the edge data (e.g., to identify or confirm nodes having a particular e-mail program). As another example, where nodes communicate via the Secure Shell (SSH) protocol, the edge information can be used to traverse the graph data and identify nodes having software using the SSH protocol. In embodiments, one or more of these graph estimation algorithm(s) 420 are selected with parameters applied based on, e.g., the nature or type of asset to be tracked, the estimation requirements (e.g., precision/accuracy or error rates), etc.

Using any one or more of such graph estimation algorithms, the accuracy and precision of the resulting graph estimation are dependent on the number of walks performed and/or the degree of network depth traversed, as well as the selection of starting node(s). For examples, the graph estimator 400 includes parameters 430 for setting or adjusting the operation of the graph estimation algorithm 420. Parameters 430 include, in embodiments, the number of walks, e.g. random walks (RWs), or number of random samples to employ (block 432), and/or the traversal depth for traversing the graph data 410 (block 434). In some embodiments, when applying a plurality of random walks a different starting node is selected for each walk. As one example, parameters 430 could be set to perform 10 random walks or use 10 random sample nodes, and traverse the graph data to a depth of 3 layers. In some embodiments, other parameter selections are made based on, e.g., a desired precision/accuracy or error rate. In some embodiments, parameters (e.g., constraints) such as traversal time, number of edge characteristics, traffic weighting, or node weighting are used to control (e.g., bound) the walk process. For example, the deeper the depth traversed, the longer the process will take, thus setting a time constraint will impact the depth of traversal. As another example, if higher traffic is weighted more than lighter traffic, then nodes having higher traffic are more likely to be traversed in the walk process. As another example, if server nodes are weighted more heavily than client nodes, then server nodes will be more likely to be traversed in the walk process than client devices.

One or more starting node(s) 440 are, in embodiments, selected for applying the particular graph estimation algorithm(s) 420. In embodiments, the starting node(s) 440 are selected at random (e.g., for random sampling). In embodiments, machine intelligence such as, e.g., machine learning or intelligence from an external feed (e.g., a downstream system such as an asset management system) is used to select the starting node(s) 440. Machine intelligence for selecting the starting node(s) 440 is based, in some embodiments, on a historical asset estimation (block 442) or a current asset inventory (block 444). In some embodiments, an external feed includes predefined criteria for selecting the starting node(s) 440.

The graph estimation results 450 include, in embodiments, an estimated size of a network data graph represented by the graph data 410. For example, estimated size can include an estimate of the number of nodes in the network, an estimate of the number of nodes having the tracked assets (e.g., as confirmed via peer-to-peer polling), of the number of nodes having particular characteristics, an estimate of the number of edges having particular characteristics, etc. The graph estimation results 450 are generated by the graph estimator 400 for use by other components of the system 200, e.g., by the asset estimator 240 (FIG. 2, already discussed) and/or the dashboard and reporting interface 250 (FIG. 2, already discussed).

Some or all aspects of the graph estimator 400 as described herein can be implemented via a central processing unit (CPU), a graphics processing unit (GPU), an artificial intelligence (AI) accelerator, a field programmable gate array (FPGA) accelerator, an application specific integrated circuit (ASIC), and/or via a processor with software, or in a combination of a processor with software and an FPGA or ASIC. More particularly, aspects of the graph estimator 400 can be implemented in one or more modules as a set of program or logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations of the graph estimator 400 can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 4B provides a block diagram illustrating aspects of an example asset estimator 460 according to one or more embodiments, with reference to components and features described herein including but not limited to the figures and associated description. In embodiments, the asset estimator 460 corresponds to the asset estimator 240 (FIG. 2, already discussed). The asset estimator 460 receives as input the graph estimation results 450 from the graph estimator 400 and determines an estimate of the tracked assets based on the graph estimation results 450 (e.g., an estimated graph size). In embodiments, the asset estimator 460 applies an estimator/algorithm 470 to provide the asset estimation results 480. For example, in some embodiments the estimator/algorithm 470 simply counts nodes or edges in the graph estimation results 450 or applies a count of nodes or edges from the graph estimation results 450. As an example, where the graph estimation results include nodes identified as having tracked assets and nodes not having tracked assets, the estimator/algorithm 470 can count the number of nodes having tracked assets to provide the asset estimation results 480 for the tracked assets.

In embodiments, the estimator/algorithm 470 provides an asset estimation useful for identifying potential security risks or performance issues presented by certain assets, asset classes, asset types, asset counts, etc. As an example, the estimator/algorithm 470 estimates software installations or hardware devices in the network having a certain version or having a version lower (e.g., older) than a threshold or required version, which enables estimating assets that, e.g., have known security vulnerabilities or performance weaknesses. As another example, the estimator/algorithm 470 estimates the presence of third party applications or devices in the network (e.g., unauthorized assets or assets from vendors known to provide software or hardware having security issues), which enables estimating assets presenting additional or unknown security vulnerabilities and/or a potential performance drain on the network. Examples such as these provide important asset estimation results, not only for identifying individual risks, but also because a homogeneous (or near homogeneous) network having authorized assets with the same asset versions better enables tracking/identification of potential network security risks/vulnerabilities and/or performance issues.

As another example, the estimator/algorithm 470 estimates estimate the number of devices in any particular area or zone, which enables determining, e.g., whether there are too many devices in a particular zone that drives network performance down, or whether there is excess capacity in a zone that can be better utilized. As another example, the estimator/algorithm 470 estimates the presence of software or hardware assets in the wrong location or zone, which enables estimating potential security risks or performance problems presented by such out-of-place assets. As another example, the estimator/algorithm 470 estimates the presence of software or hardware assets having an intermittent or transitory presence (e.g., software applications or hardware devices operated only intermittently), which enables estimating the presence of such assets that otherwise are very difficult to track because of the intermittent or transitory nature.

In embodiments, the estimator/algorithm 470 employs one or more of a historical asset estimation 472 or an asset type 474 in determining the asset estimation results 480. Thus, for example if the tracked asset is a software application and the graph estimation results include nodes identified as having the software application installed thereon, the estimator/algorithm 470 can count the estimated number of nodes reported as having the application installed to determine an estimate of the number of installations (e.g., seats) for the software asset (software application). As another example, the estimator/algorithm 470 can be used to estimate various other types of software assets, such as the number of installations of a particular open source library, or software programs that are present without a licensed server. In some embodiments, the estimator/algorithm 470 can apply a multiplier to the graph estimation results 450 (e.g., based on the historical estimation 472 or the asset type 474) to provide a determination for the asset estimation results 480. For example, if the tracked asset is a mobile device and the graph estimation results include nodes identified as the type of mobile device, the estimator/algorithm 470 can count the estimated number of nodes reported as the mobile type and modify the estimate by a multiplier that accounts for the intermittent nature of mobile devices and of their detection. Such estimates or multipliers can be based, e.g., on historical data. In other examples, the estimator/algorithm 470 can apply multipliers for estimating other assets having an intermittent or transitory nature or having characteristics that change over time.

Some or all aspects of the asset estimator 460 as described herein can be implemented via a central processing unit (CPU), a graphics processing unit (GPU), an artificial intelligence (AI) accelerator, a field programmable gate array (FPGA) accelerator, an application specific integrated circuit (ASIC), and/or via a processor with software, or in a combination of a processor with software and an FPGA or ASIC. More particularly, aspects of the asset estimator 460 can be implemented in one or more modules as a set of program or logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations of the asset estimator 460 can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 5 provides a block diagram illustrating aspects of an example dashboard and reporting interface 500 according to one or more embodiments, with reference to components and features described herein including but not limited to the figures and associated description. In embodiments, the dashboard and reporting interface 500 corresponds to the dashboard and reporting interface 250 (FIG. 2, already discussed). The dashboard and reporting interface 500 provides reporting information and visualization (block 510) to users regarding tracked network assets based on the graph estimation results 450 (from the graph estimator 400) and asset estimation results 480 (from the asset estimator 460). Reporting information is provided as output reporting data 520.

Visualizations provided by the dashboard and reporting interface 500 include one or more of a network estimation status (block 512), results of asset estimations (block 514), etc. Interactive components enable system operators (e.g., administrators) to enter selections (block 516) to refine parameters (block 518) and/or focus on particular elements or highlight particular types of activity, for use in providing reporting data and/or visualizations. Selected parameters (block 518) can include, e.g., scheduling parameters and/or parameters (e.g., the parameters 430) for use in the graph estimation algorithm 420 (FIG. 4A, already discussed). Interactive selections are provided, e.g., via an interactive user interface.

The dashboard and reporting interface 500 further includes determining scheduling (block 530) for performing any one or more of the functions of the network asset tracking system (e.g., the network asset tracking system 200 in FIG. 2, already discussed)—including collection of network data for graph generation. Scheduling can be based on parameters that include, e.g., a polling frequency for polling or monitoring/collecting network data (block 532), and/or one or more threshold(s) (e.g., trigger(s)) for monitoring/collecting network data (block 534). For example, the polling frequency (block 532) can provide for monitoring/collecting data, generating estimated graph data, and/or determining asset estimations, on a periodic basis (e.g., on a weekly basis, monthly basis, etc.). As another example, polling frequency or thresholds/triggers can provide for performing one or more of these functions on a continuous (or near-continuous) basis. In some embodiments employing a continuous monitoring or polling, aspects such as a starting node, depth of traversal or even particular graph estimation algorithm can be subject to random selection.

Parameters for thresholds or triggers (block 534) can include, for example, values based on estimated device assets—such as, for example, a number of devices or device types (e.g., a large number of mobile devices) estimated for the network. Scheduling also includes aspects for remediation/check (block 536) relating to triggers/thresholds (block 534) or asset estimations (e.g., based on information from an external feed such as a downstream asset management system).

Some or all aspects of the dashboard and reporting interface 500 as described herein can be implemented via a central processing unit (CPU), a graphics processing unit (GPU), an artificial intelligence (AI) accelerator, a field programmable gate array (FPGA) accelerator, an application specific integrated circuit (ASIC), and/or via a processor with software, or in a combination of a processor with software and an FPGA or ASIC. More particularly, aspects of the dashboard and reporting interface 500 can be implemented in one or more modules as a set of program or logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations of the dashboard and reporting interface 500 can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 6 provides a block diagram illustrating aspects of an example integration module 600 according to one or more embodiments, with reference to components and features described herein including but not limited to the figures and associated description. In embodiments, the integration module 600 corresponds to the integration module 260 (FIG. 2, already discussed). The integration module 600 takes input data, such as the reporting data 520 (from the dashboard and reporting interface 500), and provides for (block 610) network remediation via, e.g., an interface with a network manager 650, as well as exchange of data feeds and/or parameters with one or more downstream asset management system(s) 660. Remediation in block 610 can include implementing one or more actions, adjustments, modifications, etc. to the network (sent, for example, as instructions to the network manager 650) in response to the asset estimation information in the reporting data 520. For example, one or more remediation actions can be taken to address a security vulnerability and/or a performance issue identified based on the asset estimation. As an example, per block 610 the integration module 600 sends instructions to initiate (e.g., trigger) firewall, network segmentation, encryption and/or antivirus measures, and/or to increase the provision of these measures. Such a remediation action can be responsive, e.g., to an asset estimation identifying a block of assets having known security vulnerabilities—such as, e.g., based on hardware/software version, hardware/software provided by certain third parties, and/or hardware/software in an unauthorized zone, etc.

As another example, per block 610 the integration module 600 sends instructions to increase (or decrease) capacity in the network (or in a zone or part of the network). Increasing (or decreasing) capacity can be responsive, e.g., to an asset estimation identifying a larger (or smaller) than expected group of particular assets in one or more zones in the network. Capacity changes can also, for example, be timed to coincide with peak asset usage in particular zones at particular times of the day (such as, e.g., geographic zones where peak usage corresponds to daytime business hours). Capacity changes can include increasing or decreasing network bandwidth in zones, shifting assets (e.g., servers) between zones, etc. In addition, asset allocation can be modified in response to asset estimation information, for example to better match assets to distribution of personnel and/or customers across zones. Thus, in accordance with embodiments, the asset estimation information in the reporting data 520 (e.g., as in the examples described herein) enables the system to identify security vulnerabilities and performance issues and to scale remediation actions across the network or zone-by-zone, through interfacing with the network manager 650 (which, in embodiments, corresponds to the data center manager 130 in FIG. 1, already discussed). In some embodiments, the asset estimates are also used for making decisions on future asset allocation, and for adjusting future purchases or licensing of assets.

In embodiments, the integration module 600 per block 610 interfaces with the downstream asset management system(s) 660. For example, per block 610 the integration module 600 sends asset estimation data (e.g., based on the reporting data 520) to the downstream asset management system(s) 660, where the intelligence gathered and determined by the asset tracking system could be ingested, processed, and further acted upon. Asset information data to be sent to the downstream asset management system(s) 660 can be based on (or modified by) parameters or selections relating to content to be provided (block 620), frequency of reporting (block 630), data validation (block 640), etc. This enables data feeds to downstream systems to be tuned or modified to meet downstream system requirements, e.g., as to data content and frequency of reporting. For example, one or more of such parameters or selections can be specific to a particular downstream asset management system 660, or to a type of tracked asset, etc.

In embodiments, the integration module 600 receives via block 610 asset information from the downstream asset management system(s) 660. The received asset information can be used, e.g., to combine with the asset estimation results to provide for better estimation or to validate the results. For example, the asset estimation can be validated in view of data relating to expected inventory (based, e.g., on purchase or license records, usage data, etc.). If the asset estimation results exceed the asset inventory information received from the downstream asset management system 660 by a threshold amount, this can trigger a review (e.g., check/inquiry) of network data provided by the network graph generator and results provided by the graph estimator. In embodiments, remediation and/or other system modifications can be provided by the integration module 600 to the dashboard and reporting interface 500.

Some or all aspects of the integration module 600 as described herein can be implemented via a central processing unit (CPU), a graphics processing unit (GPU), an artificial intelligence (AI) accelerator, a field programmable gate array (FPGA) accelerator, an application specific integrated circuit (ASIC), and/or via a processor with software, or in a combination of a processor with software and an FPGA or ASIC. More particularly, aspects of the integration module 600 can be implemented in one or more modules as a set of program or logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations of the integration module 600 can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

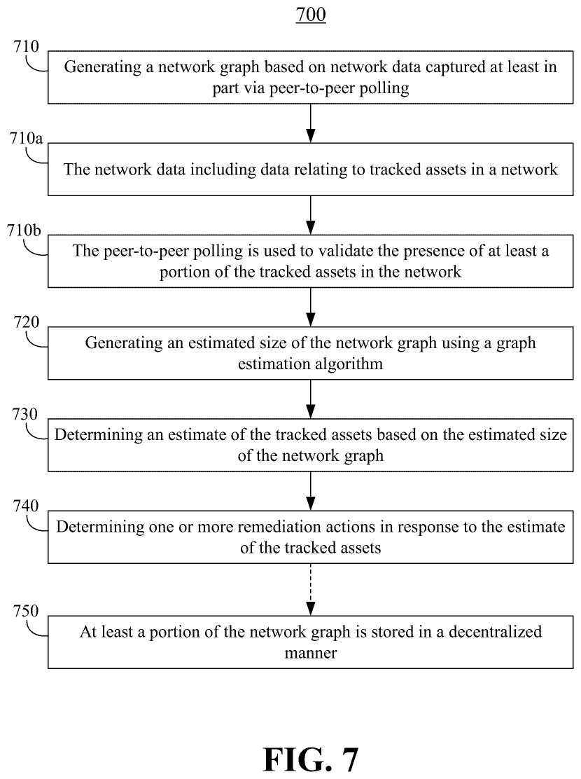

FIG. 7 provides a flow diagram illustrating an example of a method 700 of tracking network assets according to one or more embodiments, with reference to components and features described herein including but not limited to the figures and associated description. The method 700 is generally performed within a networked infrastructure environment such as, for example, the networked infrastructure environment 100 (FIG. 1, already discussed). The method 700 (or at least aspects thereof) can generally be implemented in the network asset tracking system 140 (FIG. 1, already discussed) and/or the network asset tracking system 200 (FIG. 2, already discussed).

More particularly, the method 700 can be implemented as one or more modules as a set of logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations shown in the method 700 and/or functions associated therewith can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 710 provides for generating a network graph based on network data captured at least in part via peer-to-peer polling, the network data including at block 710a data relating to tracked assets in a network, where at block 710b the peer-to-peer polling is used to validate the presence of at least a portion of the tracked assets in the network. The network data includes data captured from one or more network nodes. In some embodiments, the first set of network traffic data includes data representing one or more of a transaction duration or a volume of data transferred. In some embodiments, the first set of network traffic data is weighted based on one or more of a count or frequency of transmissions, and/or characteristics of network data. In some embodiments, the characteristics of network data includes one or more of a particular pattern of network traffic, communication over a particular port, and/or communication using a particular protocol. In embodiments, a different filtering or weighting is applied based on the kind of graph or graph characteristics. In some embodiments, the network data is a first set of network data captured in a first time frame.

Illustrated processing block 720 provides for generating an estimated size of the network graph using a graph estimation algorithm. In some embodiments, the graph estimation algorithm includes one or more of a random walk algorithm, a random sampling algorithm, or an induced edges algorithm.

Illustrated processing block 730 provides for determining an estimate of the tracked assets based on the estimated size of the network graph. In some embodiments, determining an estimate of the tracked assets is further based on one or more of a historical asset estimation or an asset type.

Illustrated processing block 740 provides for determining one or more remediation actions in response to the estimate of the tracked assets. In some embodiments, the one or more remediation actions is responsive to a security vulnerability identified based on the estimate of the tracked assets. In some embodiments, the one or more remediation actions includes one or more of firewall, network segmentation, encryption or antivirus measures. In some embodiments, the one or more remediation actions is responsive to a performance issue identified based on the estimate of the tracked assets. In some embodiments, the one or more remediation actions includes one or more of a change in network capacity or a change in allocation of network assets.

In some embodiments, illustrated processing block 750 provides for storing at least a portion of graph data from the network traffic graph in a decentralized manner. In some embodiments, the at least a portion of graph data from the network traffic graph is stored in individual nodes and aggregated centrally.

The components, methods and features as described herein for tracking network assets operate without reliance on or using any active local or installed agents. Therefore, the technology as described herein bypasses the use of active agents, thus avoiding the processing overhead and other disadvantages presented by such active agents.

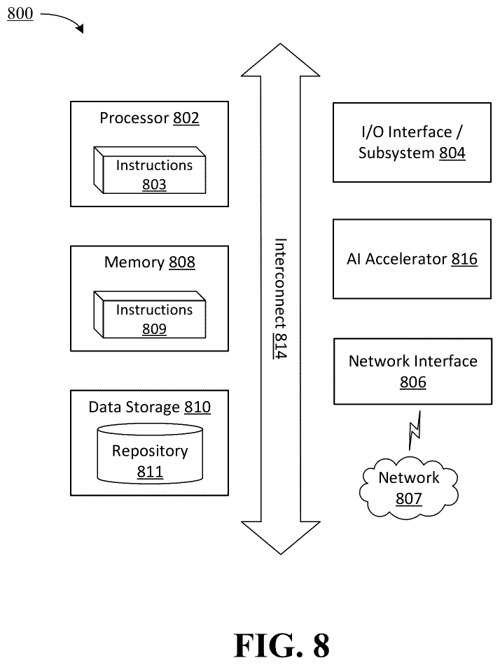

FIG. 8 is a block diagram illustrating an example of an architecture for a computing system 800 for use in a network asset tracking system according to one or more embodiments, with reference to components and features described herein including but not limited to the figures and associated description. In embodiments, the computing system 800 can be used to implement any of the devices or components described herein, including the network asset tracking system 140 (FIG. 1), the network asset tracking system 200 (FIG. 2), the network graph generator 220 (FIG. 2), the graph estimator 235 (FIG. 2), the asset estimator 240 (FIG. 2), the dashboard and reporting interface 250 (FIG. 2), the integration module 260 (FIG. 2), the network graph generator 300 (FIG. 3A), the graph estimator 400 (FIG. 4A), the asset estimator 460 (FIG. 4B), the dashboard and reporting interface 500 (FIG. 5), the integration module 600 (FIG. 6), and/or any other components of the networked infrastructure environment 100 (FIG. 1). In embodiments, the computing system 800 can be used to implement any of the processes described herein, including the process 360 (FIG. 3D), the process 380 (FIG. 3F), and/or the method 700 (FIG. 7).

The computing system 800 includes one or more processors 802, an input-output (I/O) interface/subsystem 804, a network interface 806, a memory 808, and a data storage 810. These components are coupled or connected via an interconnect 814. Although FIG. 8 illustrates certain components, the computing system 800 can include additional or multiple components coupled or connected in various ways. It is understood that not all embodiments will necessarily include every component shown in FIG. 8.

The processor 802 can include one or more processing devices such as a microprocessor, a central processing unit (CPU), a fixed application-specific integrated circuit (ASIC) processor, a reduced instruction set computing (RISC) processor, a complex instruction set computing (CISC) processor, a field-programmable gate array (FPGA), a digital signal processor (DSP), etc., along with associated circuitry, logic, and/or interfaces. The processor 802 can include, or be connected to, a memory (such as, e.g., the memory 808) storing executable instructions 809 and/or data, as necessary or appropriate. The processor 802 can execute such instructions to implement, control, operate or interface with any devices, components, features or methods described herein with reference to FIGS. 1, 2, 3A-3F, 4A-4B, 5, 6, and 7. The processor 802 can communicate, send, or receive messages, requests, notifications, data, etc. to/from other devices. The processor 802 can be embodied as any type of processor capable of performing the functions described herein. For example, the processor 802 can be embodied as a single or multi-core processor(s), a digital signal processor, a microcontroller, or other processor or processing/controlling circuit. The processor can include embedded instructions 803 (e.g., processor code).

The I/O interface/subsystem 804 can include circuitry and/or components suitable to facilitate input/output operations with the processor 802, the memory 808, and other components of the computing system 800. The I/O interface/subsystem 804 can include a user interface including code to present, on a display, information or screens for a user and to receive input (including commands) from a user via an input device (e.g., keyboard or a touch-screen device).

The network interface 806 can include suitable logic, circuitry, and/or interfaces that transmits and receives data over one or more communication networks using one or more communication network protocols. The network interface 806 can operate under the control of the processor 802, and can transmit/receive various requests and messages to/from one or more other devices (such as, e.g., any one or more of the devices illustrated herein with reference to FIGS. 1, 2, 3A-3F, 4A-4B, 5, and 6. The network interface 806 can include wired or wireless data communication capability; these capabilities can support data communication with a wired or wireless communication network, such as the network 807, the external network 50 (FIG. 1), the internal network 120 (FIG. 1), and/or further including the Internet, a wide area network (WAN), a local area network (LAN), a wireless personal area network, a wide body area network, a cellular network, a telephone network, any other wired or wireless network for transmitting and receiving a data signal, or any combination thereof (including, e.g., a Wi-Fi network or corporate LAN). The network interface 806 can support communication via a short-range wireless communication field, such as Bluetooth, NFC, or RFID. Examples of network interface 806 can include, but are not limited to, an antenna, a radio frequency transceiver, a wireless transceiver, a Bluetooth transceiver, an ethernet port, a universal serial bus (USB) port, or any other device configured to transmit and receive data.

The memory 808 can include suitable logic, circuitry, and/or interfaces to store executable instructions and/or data, as necessary or appropriate, when executed, to implement, control, operate or interface with any devices, components, features or methods described herein with reference to FIGS. 1, 2, 3A-3F, 4A-4B, 5, 6, and 7. The memory 808 can be embodied as any type of volatile or non-volatile memory or data storage capable of performing the functions described herein, and can include a random-access memory (RAM), a read-only memory (ROM), write-once read-multiple memory (e.g., EEPROM), a removable storage drive, a hard disk drive (HDD), a flash memory, a solid-state memory, and the like, and including any combination thereof. In operation, the memory 808 can store various data and software used during operation of the computing system 800 such as operating systems, applications, programs, libraries, and drivers. The memory 808 can be communicatively coupled to the processor 802 directly or via the I/O subsystem 804. In use, the memory 808 can contain, among other things, a set of machine instructions 809 which, when executed by the processor 802, causes the processor 802 to perform operations to implement embodiments of the present disclosure.

The data storage 810 can include any type of device or devices configured for short-term or long-term storage of data such as, for example, memory devices and circuits, memory cards, hard disk drives, solid-state drives, non-volatile flash memory, or other data storage devices. The data storage 810 can include or be configured as a database, such as a relational or non-relational database, or a combination of more than one database. In some embodiments, a database or other data storage can be physically separate and/or remote from the computing system 800, and/or can be located in another computing device, a database server, on a cloud-based platform, or in any storage device that is in data communication with the computing system 800. In embodiments, the data storage 810 includes a data repository 811, which in embodiments can include data for a specific application. In embodiments, the data repository 811 stores network traffic graph data received or generated as described herein).

The interconnect 814 can include any one or more separate physical buses, point to point connections, or both connected by appropriate bridges, adapters, or controllers. The interconnect 814 can include, for example, a system bus, a Peripheral Component Interconnect (PCI) bus, a HyperTransport or industry standard architecture bus, a small computer system interface (SCSI) bus, a universal serial bus (USB), IIC (I2C) bus, or an Institute of Electrical and Electronics Engineers (IEEE) standard 694 bus (e.g., “Firewire”), or any other interconnect suitable for coupling or connecting the components of the computing system 800.

In some embodiments, the computing system 800 also includes an accelerator, such as an artificial intelligence (AI) accelerator 816. The AI accelerator 816 includes suitable logic, circuitry, and/or interfaces to accelerate artificial intelligence applications, such as, e.g., artificial neural networks, machine vision and machine learning applications, including through parallel processing techniques. In one or more examples, the AI accelerator 816 can include hardware logic or devices such as, e.g., a graphics processing unit (GPU) or an FPGA. The AI accelerator 816 can implement any one or more devices, components, features or methods described herein with reference to FIGS. 1, 2, 3A-3F, 4A-4B, 5, 6, and 7.

In some embodiments, the computing system 800 also includes a display (not shown in FIG. 8). In some embodiments, the computing system 800 also interfaces with a separate display such as, e.g., a display installed in another connected device (not shown in FIG. 8). The display can be any type of device for presenting visual information, such as a computer monitor, a flat panel display, or a mobile device screen, and can include a liquid crystal display (LCD), a light-emitting diode (LED) display, a plasma panel, or a cathode ray tube display, etc. The display can include a display interface for communicating with the display. In some embodiments, the display can include a display interface for communicating with a display external to the computing system 800.

In some embodiments, one or more of the illustrative components of the computing system 800 can be incorporated (in whole or in part) within, or otherwise form a portion of, another component. For example, the memory 808, or portions thereof, can be incorporated within the processor 802. As another example, the I/O interface/subsystem 804 can be incorporated within the processor 802 and/or code (e.g., instructions 809) in the memory 808. In some embodiments, the computing system 800 can be embodied as, without limitation, a mobile computing device, a smartphone, a wearable computing device, an Internet-of-Things device, a laptop computer, a tablet computer, a notebook computer, a computer, a workstation, a server, a multiprocessor system, and/or a consumer electronic device.

In some embodiments, the computing system 800, or portion(s) thereof, is/are implemented in one or more modules as a set of logic instructions stored in at least one non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

Embodiments of each of the above systems, devices, components and/or methods, including those in the networked infrastructure environment 100, the network asset tracking system 140 (FIG. 1), the network asset tracking system 200 (FIG. 2), the network graph generator 220 (FIG. 2), the graph estimator 235 (FIG. 2), the asset estimator 240 (FIG. 2), the dashboard and reporting interface 250 (FIG. 2), the integration module 260 (FIG. 2), the network graph generator 300 (FIG. 3A), the graph estimator 400 (FIG. 4A), the asset estimator 460 (FIG. 4B), the dashboard and reporting interface 500 (FIG. 5), the integration module 600 (FIG. 6), the process 360, the process 380, and/or the method 700, and/or any other system, devices, components, or methods can be implemented in hardware, software, or any suitable combination thereof. For example, implementations can be made using one or more of a CPU, a GPU, an AI accelerator, a FPGA accelerator, an ASIC, and/or via a processor with software, or in a combination of a processor with software and an FPGA or ASIC, and/or in one or more modules as a set of program or logic instructions stored in a machine- or computer-readable storage medium such as RAM, ROM, PROM, firmware, flash memory, etc. For example, hardware implementations may include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

Alternatively, or additionally, all or portions of the foregoing systems, devices, components and/or methods can be implemented in one or more modules as a set of program or logic instructions stored in a machine- or computer-readable storage medium such as RAM, ROM, PROM, firmware, flash memory, etc., to be executed by a processor or computing device. For example, computer program code to carry out the operations of the components can be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages.

### Additional Notes and Examples:

Example M1 includes, in a network comprising a plurality of connected devices, a computer-implemented method comprising generating a network graph based on network data captured at least in part via peer-to-peer polling, the network data including data relating to tracked assets in a network, wherein the peer-to-peer polling is used to validate a presence of at least a portion of the tracked assets in the network, generating an estimated size of the network graph using a graph estimation algorithm, determining an estimate of the tracked assets based on the estimated size of the network graph, and determining one or more remediation actions in response to the estimate of the tracked assets.

Example M2 includes the method of Example M1, wherein at least a portion of the network graph is stored in a decentralized manner.

Example M3 includes the method of Example M1 or M2, wherein the graph estimation algorithm includes one or more of a random walk algorithm, a random sampling algorithm, or an induced edges algorithm.

Example M4 includes the method of Example M1, M2 or M3, wherein the graph estimation algorithm is controlled using one or more parameters relating to traversal time, number of edge characteristics, traffic weighting, or node weighting.

Example M5 includes the method of any of Examples M1-M4, wherein determining an estimate of the tracked assets is further based on one or more of a historical asset estimation or an asset type.

Example M6 includes the method of any of Examples M1-M5, further comprising determining a schedule for collecting network data based on one or more of a polling frequency or a threshold related to estimated device assets.

Example M7 includes the method of any of Examples M1-M6, wherein the one or more remediation actions is responsive to a security vulnerability identified based on the estimate of the tracked assets.

Example M8 includes the method of any of Examples M1-M7, wherein the one or more remediation actions includes one or more of firewall, network segmentation, encryption or antivirus measures.

Example M9 includes the method of any of Examples M1-M8, wherein the one or more remediation actions is responsive to a performance issue identified based on the estimate of the tracked assets.

Example M10 includes the method of any of Examples M1-M9, wherein the one or more remediation actions includes one or more of a change in network capacity or a change in allocation of network assets.

Example S1 includes a computing system comprising a processor, and a memory coupled to the processor, the memory comprising instructions which, when executed by the processor, cause the computing system to perform operations comprising generating a network graph based on network data captured at least in part via peer-to-peer polling, the network data including data relating to tracked assets in a network, wherein the peer-to-peer polling is used to validate a presence of at least a portion of the tracked assets in the network, generating an estimated size of the network graph using a graph estimation algorithm, determining an estimate of the tracked assets based on the estimated size of the network graph, and determining one or more remediation actions in response to the estimate of the tracked assets.

Example S2 includes the computing system of Example S1, wherein at least a portion of the network graph is stored in a decentralized manner.

Example S3 includes the computing system of Example S1 or S2, wherein the graph estimation algorithm includes one or more of a random walk algorithm, a random sampling algorithm, or an induced edges algorithm.

Example S4 includes the computing system of Example S1, S2 or S3 wherein the graph estimation algorithm includes one or more of a random walk algorithm, a random sampling algorithm, or an induced edges algorithm.

Example S5 includes the computing system of any of Examples S1-S4, wherein determining an estimate of the tracked assets is further based on one or more of a historical asset estimation or an asset type.

Example S6 includes the computing system of any of Examples S1-S5, wherein the instructions, when executed, further cause the computing system to perform operations comprising determining a schedule for collecting network data based on one or more of a polling frequency or a threshold related to estimated device assets.

Example S7 includes the computing system of any of Examples S1-S6, wherein the one or more remediation actions is responsive to a security vulnerability identified based on the estimate of the tracked assets.

Example S8 includes the computing system of any of Examples S1-S7, wherein the one or more remediation actions includes one or more of firewall, network segmentation, encryption or antivirus measures.

Example S9 includes the computing system of any of Examples S1-S8, wherein the one or more remediation actions is responsive to a performance issue identified based on the estimate of the tracked assets.

Example S10 includes the computing system of any of Examples S1-S9, wherein the one or more remediation actions includes one or more of a change in network capacity or a change in allocation of network assets.

Example C1 includes at least one computer readable storage medium comprising a set of instructions which, when executed by a computing device, cause the computing device to perform operations comprising generating a network graph based on network data captured at least in part via peer-to-peer polling, the network data including data relating to tracked assets in a network, wherein the peer-to-peer polling is used to validate a presence of at least a portion of the tracked assets in the network, generating an estimated size of the network graph using a graph estimation algorithm, determining an estimate of the tracked assets based on the estimated size of the network graph, and determining one or more remediation actions in response to the estimate of the tracked assets.

Example C2 includes the at least one computer readable storage medium of Example C1, wherein at least a portion of the network graph is stored in a decentralized manner.

Example C3 includes the at least one computer readable storage medium of Example C1 or C2, wherein the graph estimation algorithm includes one or more of a random walk algorithm, a random sampling algorithm, or an induced edges algorithm.

Example C4 includes the at least one computer readable storage medium of Example C1, C2 or C3 wherein the graph estimation algorithm includes one or more of a random walk algorithm, a random sampling algorithm, or an induced edges algorithm.

Example C5 includes the at least one computer readable storage medium of any of Examples C1-C4, wherein determining an estimate of the tracked assets is further based on one or more of a historical asset estimation or an asset type.

Example C6 includes the at least one computer readable storage medium of any of Examples C1-05, wherein the instructions, when executed, further cause the computing device to perform operations comprising determining a schedule for collecting network data based on one or more of a polling frequency or a threshold related to estimated device assets.

Example C7 includes the at least one computer readable storage medium of any of Examples C1-C6, wherein the one or more remediation actions is responsive to a security vulnerability identified based on the estimate of the tracked assets.

Example C8 includes the at least one computer readable storage medium of any of Examples C1-C7, wherein the one or more remediation actions includes one or more of firewall, network segmentation, encryption or antivirus measures.

Example C9 includes the at least one computer readable storage medium of any of Examples C1-C8, wherein the one or more remediation actions is responsive to a performance issue identified based on the estimate of the tracked assets.

Example C10 includes the at least one computer readable storage medium of any of Examples C1-C9, wherein the one or more remediation actions includes one or more of a change in network capacity or a change in allocation of network assets.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. In a network comprising a plurality of connected devices, a computer-implemented method comprising:
generating a network graph based on network data captured at least in part via peer-to-peer polling, the network data including data relating to tracked assets in a network, wherein the peer-to-peer polling is used to validate a presence of at least a portion of the tracked assets in the network;
generating an estimated size of the network graph using a graph estimation algorithm;
determining an estimate of the tracked assets based on the estimated size of the network graph; and
determining one or more remediation actions in response to the estimate of the tracked assets.

2. The method of claim 1, wherein at least a portion of the network graph is stored in a decentralized manner.

3. The method of claim 1, wherein the graph estimation algorithm includes one or more of a random walk algorithm, a random sampling algorithm, or an induced edges algorithm.

4. The method of claim 3, wherein the graph estimation algorithm is controlled using one or more parameters relating to traversal time, number of edge characteristics, traffic weighting, or node weighting.

5. The method of claim 1, wherein determining an estimate of the tracked assets is further based on one or more of a historical asset estimation or an asset type.

6. The method of claim 1, further comprising determining a schedule for collecting network data based on one or more of a polling frequency or a threshold related to estimated device assets.

7. The method of claim 1, wherein the one or more remediation actions is responsive to a security vulnerability identified based on the estimate of the tracked assets.

8. The method of claim 7, wherein the one or more remediation actions includes one or more of firewall, network segmentation, encryption or antivirus measures.

9. The method of claim 1, wherein the one or more remediation actions is responsive to a performance issue identified based on the estimate of the tracked assets.

10. The method of claim 9, wherein the one or more remediation actions includes one or more of a change in network capacity or a change in allocation of network assets.

11. A computing system comprising:
a processor; and
a memory coupled to the processor, the memory comprising instructions which, when executed by the processor, cause the computing system to perform operations comprising:
generating a network graph based on network data captured at least in part via peer-to-peer polling, the network data including data relating to tracked assets in a network, wherein the peer-to-peer polling is used to validate a presence of at least a portion of the tracked assets in the network;
generating an estimated size of the network graph using a graph estimation algorithm;
determining an estimate of the tracked assets based on the estimated size of the network graph; and
determining one or more remediation actions in response to the estimate of the tracked assets.

12. The computing system of claim 11, wherein at least a portion of the network graph is stored in a decentralized manner, wherein the graph estimation algorithm includes one or more of a random walk algorithm, a random sampling algorithm, or an induced edges algorithm, and wherein the graph estimation algorithm is controlled using one or more parameters relating to traversal time, number of edge characteristics, traffic weighting, or node weighting.

13. The computing system of claim 11, wherein the instructions, when executed, further cause the computing system to perform operations comprising determining a schedule for collecting network data based on one or more of a polling frequency or a threshold related to estimated device assets, and wherein determining an estimate of the tracked assets is further based on one or more of a historical asset estimation or an asset type.

14. The computing system of claim 11, wherein the one or more remediation actions is responsive to a security vulnerability identified based on the estimate of the tracked assets, and wherein the one or more remediation actions includes one or more of firewall, network segmentation, encryption or antivirus measures.

15. The computing system of claim 11, wherein the one or more remediation actions is responsive to a performance issue identified based on the estimate of the tracked assets, and wherein the one or more remediation actions includes one or more of a change in network capacity or a change in allocation of network assets.

16. At least one computer readable storage medium comprising a set of instructions which, when executed by a computing device, cause the computing device to perform operations comprising:
generating a network graph based on network data captured at least in part via peer-to-peer polling, the network data including data relating to tracked assets in a network, wherein the peer-to-peer polling is used to validate a presence of at least a portion of the tracked assets in the network;
generating an estimated size of the network graph using a graph estimation algorithm;
determining an estimate of the tracked assets based on the estimated size of the network graph; and
determining one or more remediation actions in response to the estimate of the tracked assets.

17. The at least one computer readable storage medium of claim 16, wherein at least a portion of the network graph is stored in a decentralized manner, wherein the graph estimation algorithm includes one or more of a random walk algorithm, a random sampling algorithm, or an induced edges algorithm, and wherein the graph estimation algorithm is controlled using one or more parameters relating to traversal time, number of edge characteristics, traffic weighting, or node weighting.

18. The at least one computer readable storage medium of claim 16, wherein the instructions, when executed, further cause the computing device to perform operations comprising determining a schedule for collecting network data based on one or more of a polling frequency or a threshold related to estimated device assets, and wherein determining an estimate of the tracked assets is further based on one or more of a historical asset estimation or an asset type.

19. The at least one computer readable storage medium of claim 16, wherein the one or more remediation actions is responsive to a security vulnerability identified based on the estimate of the tracked assets, and wherein the one or more remediation actions includes one or more of firewall, network segmentation, encryption or antivirus measures.

20. The at least one computer readable storage medium of claim 16, wherein the one or more remediation actions is responsive to a performance issue identified based on the estimate of the tracked assets, and wherein the one or more remediation actions includes one or more of a change in network capacity or a change in allocation of network assets.
